(19) United States
(12) Patent Application Publication
(10) Pub. No.: US 2023/0208875 A1
(43) Pub. Date: Jun. 29, 2023

(54) METHOD OF FRAUD DETECTION IN TELECOMMUNICATION USING BIG DATA MINING TECHNIQUES

(71) Applicant: VIETTEL GROUP, Ha Noi City (VN)

(72) Inventors: Anh Dung Do, Ha Noi City (VN); Trung Kien Nguyen, Ha Noi City (VN); Tien Dat Do, Ha Noi City (VN)

(73) Assignee: VIETTEL GROUP, Ha Noi City (VN)

(21) Appl. No.: 17/810,188

(22) Filed: Jun. 30, 2022

(30) Foreign Application Priority Data
Dec. 24, 2021 (VN) 1-2021-08364

(51) Int. Cl. H04L 9/40; H04W 12/12

(52) U.S. Cl. CPC H04L 63/1483; H04W 12/12

(57) ABSTRACT

The present invention provides a method of fraud detection in telecommunication including 4 steps: collecting user-profiling data, analyzing encrypted text messages, extracting features, building fraudulent subscribers classification model, developing keyword rule to detect fraudulent subscribers, proposing multiple options to prevent fraudulent subscribers in realtime.

### BACKGROUND OF THE INVENTION

The disclosure provides a method which automatically detects fraudulent subscribers in telecommunication networks. Specifically, the method comprises an application to detect and block mobile phone subscribers with fraudulent behavior. In the act of smuggling, the fraudulent actors use normal subscribed sim and send special messages, make calls need to be pre-registered with the telecommunication company. This way of circumventing is also a factor affecting the revenue of the telecommunication company. Since this is a special behavior, there are not many detection technologies in practice. This invention provides a new and effective method based on natural language processing analysis and data mining user-profiling data to make decisions to detect and block fraudulent subscribers.

Many research results have showed that telecommunication companies are facing more telecommunications fraud every year. In particular, the problem mentioned in this disclosure is a type of fraud that fakes some brands and sends fake messages. This group of fraudulent subscribers are increasing strongly, that are directly affecting Viettel, which is the most popular telecomunication company in Vietnam. The fraud detection system ensures safe service, good customer experience without disturbance, and also eliminates financial losses for the telecommunication company.

There are many fraud detection system in telecommunication. This disclosure is about an optimized realtime system able to immediately detect illegal activities right after sending of message signals. In recent studies, telecommunication fraud detection system can be divided into three main strategies: rule-based systems using telecommunication knowledge, visualization analysis system using charts to detect abnormal behavior, user-profiling systems. These systems are also divided into three types of models: statistical models, machine learning models, and rule-based models. Research methods of supervised-learning are also employed to give accurate classification results such as support vector machine model, artificial neural network, and decision tree model. Besides, there are some studies about feature extraction with the goal of extracting the optimized subset of features, based on telecommunications behaviors, then applying an artificial neural network model. Feed-forward neural networks have also gained attention from many researchers.

However, the efficiency of detecting and blocking fraudulent subscribers in is not high in practice. Because the fraudulent subscribers use many devices, use tools to send many messages at time, have many sim cards to change and the content of fraud messages varies widely. With the traditional strategy based on telecommunication rule-based system, it is only effective in the first time detection, in the long run, the fraudulent subscribers change behavior, causing the system to be out of date, and the system gets low detection accuracy. In addition, some approaches to blocking fraud messages are based on a fraudulent black list, but blocking messages from black list numbers cannot be exhaustive for all and the black list needs to be updated regularly.

By recognizing the limitations of traditional methods in current application, the disclosed method of fraud detection is a strategy based on user-profiling, using data mining techniques. This approach is gaining a lot of attention in abnormal detection systems. Because of the efficiency and power of big data mining technologies, that helps the model to learn its own features of normal and fraudulent subscribers. Besides, with infrastructure for big data processing and high performance computing, taking advantage of text mining with natural language processing techniques, disclosed is an applied system with embedding model to get better detection result.

### BRIEF SUMMARY OF THE INVENTION

The invention provides a realtime detection system to make decision of blocking fraudulent subscribers in telecommunication. We applied this system in the Viettel telecomunication company and some other companies around the world. The solution is proposed to overcome the limitations of other fraud detection systems, based on three techniques: rule-based on telecommunications knowledge, content-based on privacy content and data mining result of user-profiling. The system ensures accurate detection of subscribers with fraudulent or illegal charges, helping the telecomunication company have appropriate impact on this target group, mainly increasing the experience for normal users in telecommunication.

Specifically, the invention proposes a method to detect fraudulent subscribers in telecommunication including:

### Step 1: Collecting User-Profiling Data, Analyzing Encrypted Messages.

In which, the big data processing module automatically collects historical data of subscribers' behavior over a long period of time: six months to a year. There are encrypted data via encrypted API to ensure privacy information for subscribers. The process includes cleaning data, aggregating features, building user-profiling dataset by big data processing technologies. In addition, the text processing techniques automatically transform text from subscribers to encrypted message. User-profiling features and encrypted messages are prepared for the next step;

### Step 2: Extracting Features.

In which, system concurrently extracts user-profiling features and keyword features from user's encrypted messages. With the user-profiling feature set aggregated from cdr data (call detail record) of call and message, through feature extraction model, it provides an optimal set of features that are meaningful in order to identify subscribers with fraudulent activities. Besides, natural language processing techniques are also used to explore semantic features including fraud keyword, keyword frequency. The output features in this step are ready to prepare the fraudulent subscribers classification model and the keyword rule set for the next step;

### Step 3: Building Fraudulent Subscribers Classification Model.

In this step, the fraudulent subscriber classification model is trained based on the user-profiling features extracted in step 2. Training, optimizing model's algorithm, tuning hyperparameter to get final model. The prediction of model is a set of suspected fraudulent subscribers which is updated daily;

### Step 4: Developing Keyword Rule to Detect Fraudulent Subscribers.

In this step, performed on the real-time module. Set of suspected fraudulent subscribers in previous step, is passed a filter based on keyword rule and the encrypted message characteristic when a message sends currently. The rule is complex and flexible with dynamic and static rule. If content matches defined rule, the system give final prediction: subscriber has fraud behavior. The result of the subscriber's fraudulent activity has high accuracy. Subscribers that are confirmed by system as normal, system will send signal to network operators and pass the message normally. In case, subscribers are deemed to be involved in fraud, they are pushed to the next step;

### Step 5: Proposing Multiple Options to Prevent Fraudulent Subscribers in Real Time.

The last step, system processes in the business module, with subscribers detected to be fraudulent, will be sent to validation mode. The system proposes decision making solutions for the subscription blocking. In addition, the static and dynamic rules are analyzed to modify, increase the flexibility of the system.

In step 1, the invention achieves diverse set of feature data by focusing on both user-profiling data and encrypted messages. Using data mining techniques, system is capable of execution data from multiple source and the large number of users used in a telecommunication network. This step covers the behavior of fraud and normal users in big picture;

In step 2, the invention achieves an optimal feature set that ensures no interference features and increases the performance of the classification model. Through the use of feature extraction according to the wrapper method: multivariate adaptive regression method. This statistical method ensures to capture complex, non-linear relationships between features and human characteristics. Also, this helps the system be flexible to fraudulent charges and have fast execution speed. Then, by ranking the importance of the features and evaluating the correlation, system gets a subset of the optimal user-profiling features for the fraudulent subscriber classification model;

In step 3, the invention provides a method to optimize the random forest classification model to identify fraudulent subscribers. Hyperparameters including a number of decision trees, maximum depth of tree, maximum number of leaf nodes are selected based on cross validation methods. It ensures that the model has high accuracy and avoids overfitting. The Gini criterion for each decision tree node is also used to speed up the computation. In addition, use is made of some other pre-trained models to detect shipper, automated call, and salesman, to eliminate subscribers with other behaviors from the set of suspected fraudulent subscribers;

In step 4, the invention achieves more accurate detection results. By using encrypted message, and passing text to natural language processing techniques. Mainly, extract keyword method applies to corpus of fraud messages to get keyword rules. Specially, invention mentioned dynamic rule, which can capture more fraud messages and is flexible when fraudulent subscribers change behavior.

In step 5, provided different options to block and prevent fraudulent subscribers, are suitable to the characteristics of the system. With 4 options for blocking and preventing: delay blocking, blocking message only, blocking sim card in a period and complete blocking are applied in accordance with the level of blocking. Thereby, these options bring effective blocking for the fraud detection system.

### BRIEF DESCRIPTION OF THE DRAWINGS

FIG. 1 is the flow diagram of fraud detection system, including steps of execution;

FIG. 2 is the architecture diagram of the system's operation to detect and block fraudulent subscribers in telecommunication networks.

### DETAILED DESCRIPTION OF THE INVENTION

The detailed description of the invention is interpreted in connection with the drawings, which are intended to illustrate variations of the invention without limiting the scope of the patent.

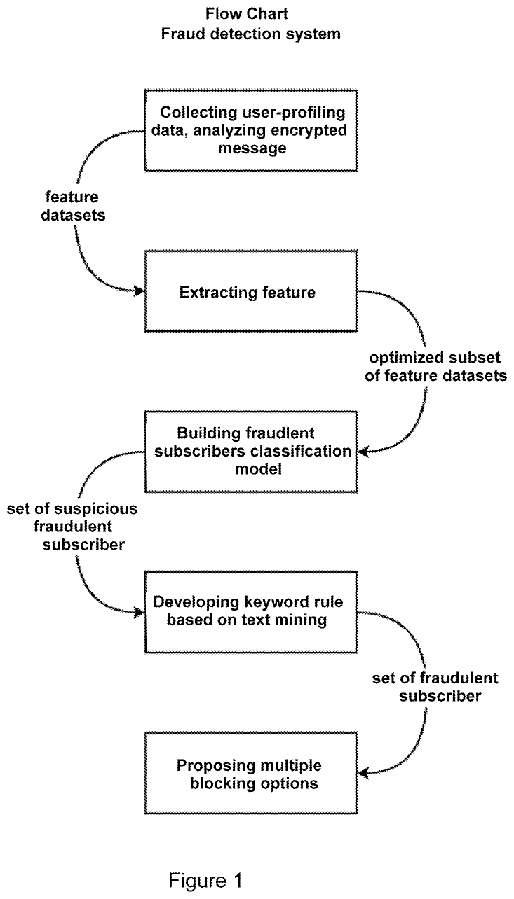

In this patent, “subscriber” is understood as the someone registered to a telecommunication carrier and subscribers send SMS messages, “user” refers to a general telecommunications user, who performs both sending and receiving of messages. The method of detection fraudulent subscribers includes the following steps (FIG. 1). Step 1: Collecting user-profiling data, analyzing encrypted text messages. The output is user-profiling feature set and encrypted message data. Step 2: Extracting features. The outputs are the optimal feature set. Step 3: Building fraudulent subscribers classification model. The output is a set of subscribers that have been labeled as suspicious. Step 4: Developing keyword rule to detect fraudulent subscribers. Outputs are subscribers who are confirmed that they have fraud behavior. Step 5: Proposing multiple options to prevent fraudulent subscribers in realtime.

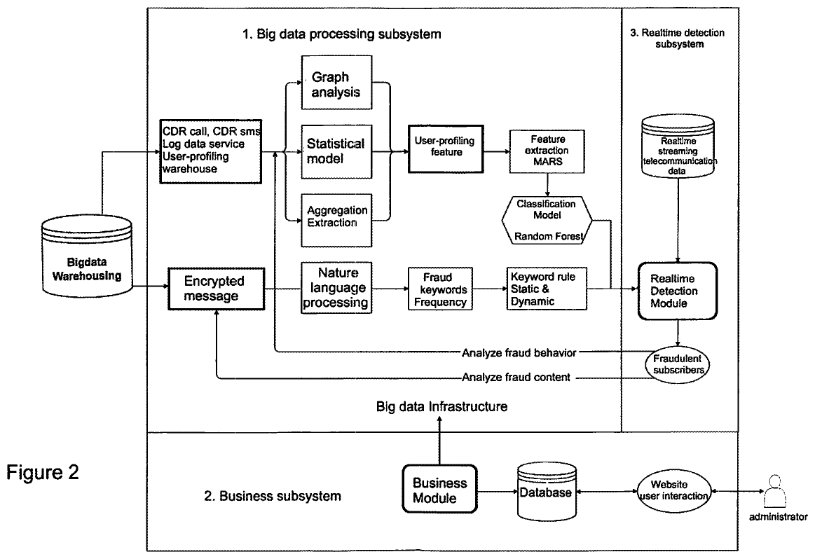

The system consists of three modules: Big data processing module, Realtime processing module and Business module (FIG. 2). The center of the system is the entire big data infrastructure (FIG. 2), which is the place to store and process data, a bridge between the three modules. From the telecommunication database layer, system collected dataset of telecommunications behavior and subscribers' encrypted messages, and users' data is encrypted to ensure information security. Big data processing stream and machine learning model are executed, combined with fraud mining streaming in realtime processing module. The data is stored in the big data infrastructure—where it connects to the business module, including the server system, which is interaction between the system, where the administrator makes a decision to block and prevent fraudulent subscribers.

Method of detecting fraudulent subscribers in telecommunication network includes:

### Step 1: Collecting User-Profiling Data, Analyzing Encrypted Text Messages.

In which, the Big data processing module (FIG. 1) automatically collects historical data of subscribers' telecommunication behavior over a long period of time (6 months to 1 year), encrypted message ensuring information security, cleaning data, aggregating features, building user-profiling datasets through big data processing technologies. In addition, the module also handles encrypted user's message, usually in the form of text, segmentation, cleaning and data preprocessing. Telecommunication behavioral dataset, user-profiling features and user's encrypted messages are prepared for the next step. Telecommunication behavioral dataset includes: traffic call & message data, service registration, 3G/4G usage data, . . . User-profiling features has characteristics such as: device usage behavior, location and movement history, relationship between users, frequency of calls made over a period of time in day, average revenue, interests . . . . User's encrypted message data consists of message segments labeled as fraud or normal. The analysis of user-profiling uses data analysis techniques such as statistical modeling, graph analysis, and time-series analysis. For large data sets (of 120 million users with a capacity of about 100 TB) stored and processed in big data processing module, realtime parallel execution and storage technology: Spark Hadoop.

### Step 2: Extracting Features

In which, system executes concurrently extracting user-profiling features and fraud keyword features from user encrypted messages. With the user-profiling features synthesized from cdr (call detail record) call and message data, through feature extraction model, it provides an optimal set of features, that is meaningful for identifying subscribers with fraudulent behavior. Besides, natural language processing techniques are also used to exploit semantic features including fraud keywords, keyword frequency. These output features are ready for classification model and keyword rules for the next step. User-profiling features contain 65 features of 80 million users. These user-profiling features go though suitable feature extraction model, to find out important features that are meaningful in detecting fraudulent subscribers. Supervised learning model is used, specifically the Multivariate adaptive regression gives the optimal set of regression coefficients of the regression model with variables of the features and output vector are users' label. Evaluating the weight of the regression coefficients in descending order, removing features with high correlation with abs(corr)>0.75. This process gives us a compact set of features contained 20 features which are most important features and increase efficiency and accuracy of classification model in the next step.

Besides, user's encrypted message dataset go through the natural language processing steps: word segmentation, part of speech tagging, and keyword extraction, text vectorization with word2vec. Based on the frequency of keywords appearing in the encrypted message corpus, sorted in descending order, for each content, we can extract the semantic features of word2vec. Base on frequency of keyword and model of semantic features, we can obtain content which score of fraud is high, then get keyword of that content with high frequency.

### Step 3: Building Fraudulent Subscribers Classification Model.

In this step, the fraudulent subscriber classification model is trained based on the user-profiling features extracted in step 2. The output is a set of suspicious subscribers which is updated daily. Summarizing the user-profiling features extracted in step 2, we have an input for machine learning classification model, we choose optimized model: random decision forest—ensemble learning algorithm. With two class classification model, each subscriber has the probability of label fraud from 0.0 to 1.0, the subscriber with a probability higher than the threshold will be classified into the set of suspected fraud. In addition, the step also uses other models, shipper detection, automated calls detection, salesman detection to remove other behavior of subscribers from set of suspicious subscribers.

### Step 4: Developing Keyword Rule to Detect Fraudulent Subscribers.

In this step, the set of subscribers suspected of fraud in step 3, is passed to a filter based on keyword rules and the user's encrypted message characteristics. This step runs in realtime detection module. This step guarantees high accuracy of final decision. The subscriber set that is confirmed to be fraudulent subscribers will be sent to a next step. Inferred from results of step 2, after extracting text data that has extracted fraud keywords, system collected set of fraud keywords with high frequency. Currently, a large number of keywords include one time password keywords, encryption keywords, application message keywords, . . . Subscribers in the set of suspicious subscriber send message, then this message will be filtered by keyword rules based on regular expression techniques. We use static rule and dynamic rule to cover the behavior of fraudulent subscribers. Finally the optimal thresholds for keyword frequency, message sending frequency, receiving rate are combined to increase the reliability of the fraud detection system.

### Step 5: Proposing Multiple Options to Prevent Fraudulent Subscribers in Realtime

Last step processes in the business module. Subscribers detected to be fraudulent, will be sent to the business validation, the invention also proposes decision-making solutions for the subscription blocking and preventing. In addition, the statistic result of static and dynamic rule built in step 4 are also proposed for the administrator. This helps to modify and increase the flexibility of the system. For the characteristics of each telecommunication carrier company, the invention provides four solutions for blocking and preventing fraudulent subscribers.

Blocking options sorted on increasing level: delay blocking, blocking message only, blocking sim card in period and complete blocking. Delay blocking determined by detection system integrated to Short message service center (SMSC), if subscribers confirmed to be fraud, system sent message to the user but slower than real time. Blocking sim card in period ensures that all messages from fraudulent subscribers can't be sent for a large period of time. Complete blocking is the strongest option, subscribers can't use any service from the telecommunication company.

In step 1, the invention achieves a diverse set of feature data. By focusing on both user-profiling data and encrypted messages, based on big data mining techniques, the system has a complete data source with large number of features of users. So that the features can cover the behavior of fraudulent subscriber and normal user.

In step 2, the invention achieves an optimal set of features that ensures no interference features and increases efficiency of the classification model. Using feature extraction according to the wrapper method, multivariable regression adaptive model, it ensures to capture complex, non-linear relationship between features and human characteristics. This method also helps execution speed be faster. Then, by ranking the importance of the features and evaluating the correlation, we give an optimal user-profiling subset feature for the fraudulent subscriber classification model.

In step 3, the random forest classification model is optimized to detect fraudulent subscriber. The hyperparameters including the number of decision trees, the maximum depth of the tree and the maximum number of leaf nodes are selected based on the verification method: Cross validation. Tuning process ensures high accuracy of the model and avoids overfitting. The Gini criterion for each decision tree node is also used to speed up the computation. In addition, using other models to detect shipper, automated calls, and salesman, to eliminate other subscribers from set of fraudulent subscribers.

In step 5, different methods of blocking and preventing fraudulent subscribers are given in accordance with the specific characteristics of the customer. The system has 4 options for blocking and preventing: delay blocking, blocking message only, blocking sim card in period and complete blocking. Thereby the system is more flexible with different purposes.

According to the next aspect, the invention provides a method of fraud detection in telecommunication where:

Step 1: telecommunication behavior data including: traffic call & message data, service registration, 3G/4G usage data.

According to the next aspect, the invention provides a method of fraud detection in telecommunication where:

Step 1: the feature sets in user-profiling data include location feature, relationship feature, device usage feature, revenue feature, interests feature.

According to the next aspect, the invention provides a method of fraud detection in telecommunication where:

Step 1: user-profiling data mining techniques used: statistical model, graph analysis, time-series analysis.

According to the next aspect, the invention provides a method of fraud detection in telecommunication where:

Step 1: data analyzing, NLP processing, data storing execute in distributed storage big data infrastructure, realtime parallel computation in big data processing engines: Apache Spark, Apache Hadoop.

According to the next aspect, the invention provides a method of fraud detection in telecommunication where:

Step 2: user-profiling feature extraction technique is based on modeling method. Multivariate adaptive regression model has large input feature set input. It produces a subset of features which is meaningful in predicting the fraudulent subscribers, increasing the accuracy, increasing system performance.

According to the next aspect, the invention provides a method of fraud detection in telecommunication where:

Step 2: feature extraction of encrypted messages includes natural language processing method in order to extract semantic features. The text mining techniques build on the entire corpus of encrypted messages include: word segmentation, n-gram, text vectorization (word2vec).

According to the next aspect, the invention provides a method of fraud detection in telecommunication where:

Step 2: technique to extract feature of encrypted messages in terms of illegal keywords combined with three techniques: word segmentation, part of speech tagging, Keyword extraction in order to extract high frequency fraud keywords.

According to the next aspect, the invention provides a method of fraud detection in telecommunication where:

Step 2: high-performance natural language processing feature extraction of encrypted messages based on Apache Hadoop distributed storage infrastructure, Machine Learning Library: Mlib and parallel computing algorithms on Apache Spark.

According to the next aspect, the invention provides a method of fraud detection in telecommunication where:

Step 3: the machine learning classification model is random forest with optimized parameters (parameters tuning). Giving a 2-class classification model for each user with the probability of fraud label from 0.0 to 1.0. Subscribers having probability more than the threshold will be classified in the set of suspicious fraudulent subscribers.

According to the next aspect, the invention provides a method of fraud detection in telecommunication where:

Step 3: about the random forest classification model, labels that are confirmed to be correctly will automatically added to the training set. The optimal classification threshold is automatically updated according to the Receiver operation characteristic to obtain the maximum Area under curve measure.

According to the next aspect, the invention provides a method of fraud detection in telecommunication where:

Step 3: other models are used to increase accuracy of system, including shipper detection, automated call detection and salesman detection. The prediction set of the classification model is filtered to remove the subscribers that are in sets of these models.

According to the next aspect, the invention provides a method of fraud detection in telecommunication where:

Step 4: the set of keywords extracted from encrypted messages in step 2, then with natural language processing techniques, semantic feature and keyword frequency to get label of content. If content is fraud content, this step extracts keywords from content and adds to set of fraud keywords.

According to the next aspect, the invention provides a method of fraud detection in telecommunication where:

Step 4: keyword rules ensures high accuracy for the system to detect fraudulent subscribers. Using output from step 3, the subscriber classified as a fraudulent subscriber will be automatically collected realtime messages via the messaging service center system (smsc). If the content satisfies the fraud keyword rules, it will be taken to step 5, processing blocking and preventing.

According to the next aspect, the invention provides a method of fraud detection in telecommunication where:

Step 4: dynamic keyword rule also mentions to increase flexibility. Using a subset of the keyword rule set, rule is dynamically configured, increasing the availability of the system to deal with the constantly changing behavior of the fraudulent subscribers.

According to the next aspect, the invention provides a method of fraud detection in telecommunication where:

Step 5: subscribers that have been confirmed and blocked will be stored and analyzed. In which, the user-profiling and encrypted messages of fraudsters are put into the big data processing module. System analyzes the data, discovers more features to improve the model over time.

According to the next aspect, the invention provides a method of fraud detection in telecommunication where:

Step 5: the option of blocking and preventing fraudulent subscribers includes temporarily blocking for a period of time. This option help to reduce effects of fraud activity to user.
Step 5: the option of delay blocking is proposed for domestic and foreign carriers that do not allow complete blocking. Fraudulent subscribers send messages. Then, message delays in message service center system (SMSC) over a large enough time (10-30 minutes), the user will receive the message. This option ensures to disable the texting purposes of the fraudulent subscribers.

### OBTAINED EFFECT OF THE INVENTION

The method fraud detection in telecommunication brings the two main effects: Markedly reduce the number of fraudulent subscribers, and number of fraud message to normal users.

Introduce service to subscribers who committed fraud, thereby lead them to the registration of brandname. Message with brandname help to increase customer experience.

Although the above descriptions contain many specifics, they are not intended to be a limitation of the embodiment of the invention, but are intended only to illustrate some preferred execution options.

What is claimed is:

1. Methods of detecting fraudulent subscribers in telecommunications comprising:
Step 1: Collecting user-profiling data, analyzing encrypted text messages,
In which, a big data processing module automatically collects historical data of subscribers' usage behavior over a long period of time (6 months to 1 year), the data is encrypted, ensures privacy information, Following steps: cleaning data, aggregating features build user-profiling data by big data processing technologies, In addition, handling encrypted messages, usually in the form of text: segmentation, text cleaning, and data preprocessing, Telecommunication behavioral dataset, user-profiling features and user's encrypted messages are prepared;
Step 2: Extracting Feature,
In which, big data processing concurrently executes user-profiling feature extraction and fraud keyword extraction from encrypted message corpus, Using the user-profiling features aggregated from call detail record of call and message, system provides an optimal subset of user-profiling features by feature extraction model, These features are meaningful in indentifying subscribers with fraudulent activities, natural language processing techniques are also used to explore semantic features, fraud keyword set and frequency of keyword, Total features extracted from multiple source are ready to be input of the classification model and keyword rules for the next step;
Step 3: Building fraudulent subscribers classification model,
In which, the fraudulent subscriber classification model is optimized, Random forest model trained based on user-profiling features extracted from step 2, The output is a set of suspicious fraudulent subscribers which is updated daily;
Step 4: Developing keyword rule to detect fraudulent subscribers,
In which, step performs in the realtime processing module, the set of subscribers are suspected, passes a filter based on keyword rule, The keyword rule contains static and dynamic rule, Currently, when a suspicious subscribers send message, if message matches the keyword rule, then subscribers are finally detected fraudulent subscribers, Detection result ensures high accuracy, the output of fraudulent subscribers are confirmed by system and send to the blocking step;
Step 5: Proposing multiple options to prevent fraudulent subscribers in realtime,
In which, four options for different realtime blocking are provided, In addition, the statistic result of static and dynamic rule built in step 4 are also proposed for the administrator, This help to modify and increase the flexibility of the system.

2. Methods of detecting fraudulent subscribers in telecommunications according claim 1, further comprising:
Step 1: User's telecommunication behavior data includes traffic of call & message data, service registration, 3G/4G usage data.

3. Methods of detecting fraudulent subscribers in telecommunications according claim 1, further comprising:
Step 1: user-profiling feature includes device usage behavior, location and movement history, relationship between users, frequency of calls made over a period of time in day, average revenue, interests.

4. Methods of detecting fraudulent subscribers in telecommunications according to claim 1, further comprising:
Step 1: user-profiling data mining techniques include: statistical model, graph analysis, time-series analysis.

5. Methods of detecting fraudulent subscribers in telecommunications according to claim 1, further comprising:
Step 1: the data analyzing, natural language processing, data storing executed in the big data infrastructure and distributed storage, realtime parallel computation execution in engines: Apache Spark, Apache Hadoop.

6. Methods of detecting fraudulent subscribers in telecommunications according to claim 1, further comprising:
Step 2: user-profiling feature extraction technique is feature extraction method based on modeling method, Modeling method is Multivariate adaptive regression which is a statistical model, is suitable for large number of samples and features.

7. Methods of detecting fraudulent subscribers in telecommunications according to claim 1, further comprising:
Step 2: feature extraction techniques of encrypted messages are natural language processing methods in order to normalize text and extract semantic features;
Step 2: keyword extraction techniques include segmentation, part of speech tagging, keyword extraction, These techniques help to extract fraud keywords with high frequency occurrence.

8. Methods of detecting fraudulent subscribers in telecommunications according to claim 1, further comprising:
Step 2: high performance natural language processing based on Apache Hadoop distributed storage infrastructure and machine learning library (mllib), This process parallel compute algorithms on Apache Spark.

9. Methods of detecting fraudulent subscribers in telecommunications according to claim 1, further comprising:
Step 3: the random forest classification model optimized hyperparameters, Model is two-class classification model for each subscriber with the probability of fraud label from 0.0 to 1.0, the subscriber has the probability that greater than the threshold will be classified into the set of suspected fraudulent subscribers;
Step 3: the machine learning classification model automatically updates threshold and updates detected sample to training set.

10. Methods of detecting fraudulent subscribers in telecommunications according to claim 1, further comprising:
Step 3: other models is used in order to increase accuracy for detection, include shipper detection, automated call detection, salesman detection, These user from these model will be eliminated from set of suspicious fraudulent subscriber.

11. Methods of detecting fraudulent subscribers in telecommunications according to claim 1, further comprising:
Step 4: the set of keywords extracted from encrypted message in step 2 is considered, using semantic feature extracted from the messages, nature language processing model labels the fraud message, Then, system creates a set of fraud keyword which contains high frequency keywords.

12. Methods of detecting fraudulent subscribers in telecommunications according to claim 1, further comprising:
Step 4: by using of keyword rule layer, system ensures high accuracy for the detection result, taking output from step 3, the suspicious fraudulent subscriber will be automatically collected encrypted messages via the messaging service center system (SMSC), If the encrypted message match the keyword rules, it will be taken to blocking and preventing step.

13. Methods of detecting fraudulent subscribers in telecommunications according to claim 1, further comprising:
Step 4: dynamic keyword rule is introduced to increase flexibility, A subset of the keyword rule will be dynamically configured, increasing the availability of the system to deal with the constantly changing behavior of the fraudulent subscribers.

14. Methods of detecting fraudulent subscribers in telecommunications according to claim 1, further comprising:
Step 5: system stores subscribers that are confirmed and blocked, then takes analysis process, In which, the user-profiling and encrypted messages of these subscribers are put into the big data processing module, This help to discover more features to improve the model by the time.

15. Methods of detecting fraudulent subscribers in telecommunications according to claim 1, further comprising:
Step 5: the temporarily blocking for a period of time option is proposed, this help to reduce effect of fraud activity to users,
Step 5: the delay blocking option is proposed for domestic and foreign carriers that do not allow one-way blocking.
